(19) United States
(12) Patent Application Publication
(10) Pub. No.: US 2003/0037045 A1
(43) Pub. Date: Feb. 20, 2003

(54) Distributed computing environment for recognition of proteomics spectra

(76) Inventor: Ian Melhado, Vancouver (CA)

Correspondence Address: BOZICEVIC, FIELD & FRANCIS LLP, 200 MIDDLEFIELD RD, SUITE 200, MENLO PARK, CA, 94025, US

(21) Appl. No.: 10/142,544

(22) Filed: May 8, 2002

Related U.S. Application Data
(60) Provisional application No. 60/292,709, filed on May 21, 2001.

(51) Int. Cl. G06F 7/00

(52) U.S. Cl. 707/3

(57) ABSTRACT

Methods are provided for efficient, computer-assisted methods for identifying, selecting and characterizing polypeptides, based on the searching of large databases in which the search strategies are executed in parallel. A local area network is used as a virtual parallel processor, distributing the search over multiple computers in a network. The system is sufficiently fast to permit the application of exhaustive search methods not previously feasible for large databases. The software system consists of three independent but cooperative programs, a client, server and viewer module.

### BACKGROUND OF THE INVENTION

The proteome of a cell or organism is the expressed protein complement of a genome. The initial tool for analysis of a proteome is often two-dimensional gel electrophoresis (2D gel). Proteins are separated on the basis of charge in the first dimension and molecular mass in the second. Typically 1000-3000 proteins per gel can be visualized, for example by staining with silver. Complementary approaches such as immunoblotting allow greater sensitivity for specific molecules. Multiple forms of individual proteins can be readily visualized, and the particular subset of proteins examined from the proteome is determined by factors such as initial sample treatment, enrichment protocols, and the like. Analysis of gel images with software allows comparisons of multiple gels both within a laboratory and to proteome databases.

Proteins of interest are identified on the basis of such methods as mass-spectrometry, which requires only small amounts of material. All mass spectrometers (MS) have three essential components that are required for measuring the mass of individual molecules that have been converted to gas-phase ions prior to detection. The components are an ion source, a mass analyzer and a detector. Ions produced in the ion source are separated in the mass analyzer by their m/z ratio, and are usually detected by a photomultiplier. MS data is recorded as “spectra” which displays ion intensity versus the m/z value. The two techniques that have become preferred methods for ionization of peptides and proteins are electrospray ionization (ESI) and matrix-assisted laser desorption/ionization (MALDI), due to their effective application to a wide range of proteins and peptides.

Although different combinations of ionization techniques and mass analyzers exist, MALDI usually uses a time-of-light (TOF) tube as a mass analyzer while ESI is traditionally combined with quadrupole mass analyzers capable of tandem mass spectrometry (MS/MS). Instruments capable of MS/MS have the ability to select ions of a particular m/z ratio from a mixture of ions, to fragment selected ions by a process called collision induced dissociation (CID) and to record the precise masses of the resulting fragment ions. If this process is applied to the analysis of peptide ions, the amino acid sequence of the peptide can be deduced.

The development of computer algorithms that correlate MS and MS/MS generated data with database information has provided a major impetus for proteomics. For example, see Clauser et al. (1995) Proc. Natl. Acad. Sci. USA 92:5072-5076; Henzel et al. (1993) Proc. Natl. Acad. Sci. USA 90:5011-5; Kaufmann et al. (1994) Int. J. Mass Spectrom. Ion Processes 131:355-385; Mann & Wilm (1994) Anal Chem 66:4390-9; Mann et al. (1993) Biol Mass Spectrom 22, 338-345; Pappin et al. (1993) Curr Biol 3:327-332; Yates et al. (1995) Anal. Chemistry 67:1426-36; Yates et al. (1993) Anal. Biochem 214:397-408. Annotated protein and two-dimensional electrophoresis databases are the bioinformatic core of proteome research. SWISS-PROT is a typical example of such an annotated database. Many proteome projects are now underway, resulting in the generation of two-dimensional electrophoresis databases that are accessible on the internet. Other databases have been developed for proprietary uses.

The use of mass spectrometry, and in particular high throughput analysis with tandem mass spectrometry, can produce thousands of spectra for analysis in complex databases. As a result, conventional software packages and microcomputers are inadequate, both in terms of speed and sensitivity. The present invention addresses this problem.

### SUMMARY OF THE INVENTION

The present invention provides an efficient, computer-assisted method for identifying, selecting and characterizing polypeptides using the data fromf large databases. The invention offers the advantage of the search strategies being executed in parallel rather than sequentially. Spectral data is obtained, usually in a high throughput manner, and the information entered into a computer system automatically.

The data is produced in discrete datasets of one fragmentation pattern per peptide by the MS, each fragmentation peptide independent of the others. The dataset for a particular sample polypeptide is searched against a reference database using a server high speed identification algorithm.

In order to improve the speed and sensitivity of the search, a local area network (LAN) is used as a virtual parallel processor, distributing the search over multiple computers in a network. The system is sufficiently fast to permit the application of exhaustive search methods not previously feasible for large databases. The software system consists of three independent but cooperative programs. Shiva Client initiates and manages the searches. Shiva Server resides on the various servers throughout the network, and is continuously running as a daemon. Shiva Viewer allows the user to view the search results.

### BRIEF DESCRIPTION OF THE DRAWINGS

FIG. 1 is a schematic representation of the hardware components of the Shiva system.

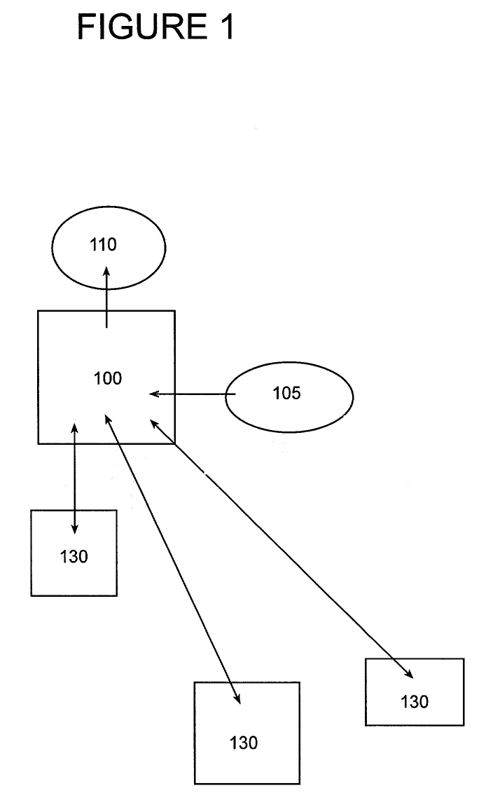

FIG. 2 is a schematic representation of the software components.

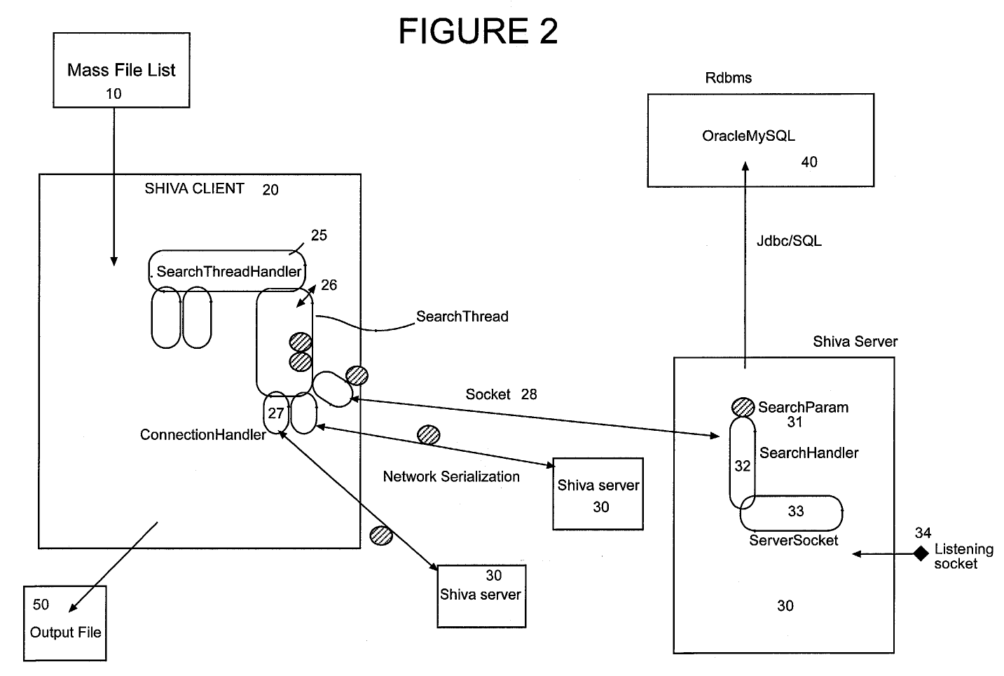

### DETAILED DESCRIPTION OF THE EMBODIMENTS

The software system of the invention, herein termed the “Shiva” system, provides three programs that work cooperatively to initiate and search databases on distributed computers connected by a LAN. The search is initiated and managed by Shiva Client, while the Shiva Server program monitors a queue, opens connections to the database, constructs and executes the search and receives the results. Shiva Viewer allows the user to access the data for analysis.

To transfer the data from a MS to a computer system for analysis, a detector or other input means 105 is operably connected to a computer 100. As used herein, the term “operably connected” includes either a direct link, for example, a permanent or intermittent connection via a conducting cable, an infra-red communicating device, or the like, or an indirect link whereby the data are transferred via an intermediate storage device for example, a server or a floppy disk. The computer is linked by a LAN to other computers 130.

Once transferred to an appropriate computer, the output can be processed to filter and remove artifacts; to detect and quantify features; and to create files. This is Shiva Viewer. The Shiva program initially opens a file containing the mass spectroscopy data, for example, in the form of mass/intensity pairs. The data is broken into individual peptides and background noise is removed. Data from duplicate peptides is also removed. Data from singly positively charged peptides is removed, and the data is sorted. The Shiva Client connects to the servers and the data is send over the LAN to the servers, one peptide at a time.

On the remote servers the data is normalized, filtered a second time, the mass of the parent ion is calculated and the central database is queried with this mass. All names, masses and sequences of the tryptic peptides having a mass within user defined tolerance parameters (the query mass) are returned. These are the “hits”. A theoretical ms/ms spectrum of each hit is generated. The spectrum from each hit is used to search the data by searching each mass in the hit against the data. If a mass match is found during this search (the base mass) a search begins for the corresponding isotope of this hit. If a mass match is found during the search for the isotope a search begins for the next isotope. Once the masses of the base mass and the isotopes have been found, based on a pre-calculated probability profile of the intensities of the isotopic peaks, the match is given a score.

This process is carried out for each element of the theoretical spectra within the tag region which is determined to be the amino acids within the N-terminal half of the peptide. The score for the peptide is the product of probabilities for finding each amino acid in question, multiplied by the score of the match as determined by the probability profile, less the score calculated from the same peptide that has been randomized. The significance of the score is determined by calculating the number of standard deviations the peptide score is from the random score. When the peptide is complete the server sends a signal back to the client which responds with the data from another peptide. This process repeats until the client responds that there are no peptides left to search. The server then sends an array containing all the hits back to the client.

Shiva Client compiles the hits from all the servers in to the search results and aggregate scores for each search result calculated as the product of the scores from the top five user defined peptides which have a sufficient significance score. The search results are sorted according to score. The description of each result is downloaded from the database. The results in the form of a name, score, peptides matches, and description are printed to an HTML file for viewing via web browser. The name of the identified protein is also coded in HTML as a link to the relevant protein entry at the NCBI database, so that the user may easily navigate to the public repository of information on the protein simply by clicking on the name. The results are also printed to a “.out” file which can be viewed using Shiva Viewer. Shiva Viewer is a part of the Shiva suite of programs which allows the user to view the amino acid matches as assigned by the program. An optional histogram may be printed.

By determining all possible combinations of amino acids that can sum to the measured mass of the peptide, having regard to water lost in forming peptide bonds, protonation, other factors that alter the measured mass of amino acids, and experimental considerations that constrain the allowed combinations of amino acids, the computer can construct an allowed library of all linear permutations of amino acids in the permitted combinations. Theoretical fragmentation spectra are then calculated for each member of the allowed library of permutations and are compared with an experimental fragmentation spectrum obtainable by mass spectrometry for the unknown peptide to determine the amino acid sequence of the unknown peptide. Once the entire or a partial amino acid sequence of an isolated protein has been experimentally determined, a computer can be used to search available databases for a matching amino acid sequence or for a nucleotide sequence, including an expressed sequence tag (EST), whose predicted amino acid sequence matches the experimentally determined amino acid sequence.

Additionally a database may be constructed which contains all theoretical tryptic peptides of all proteins within a public or private protein database by using software tools common to the art and following the rules of tryptic digestion. Taking in to consideration those peptides with sufficient mass to be detected by the mass spectrometer as well as the number of amino acids that may be modified by phosphorylation in each peptide.

### EXAMPLES

### Example 1

### Shiva Mass Spec Database Search Software

Design Premise

MS data was observed to be produced in discrete datasets of one fragmentation pattern per peptide. Each fragmentation pattern is independent of the other. Due to the nature of the data it was determined that mass spec data was a prime candidate for parallel database searching. This involves searching different peptides simultaneously on different computers. The search results are then compiled from the different computers to give an overall search result.

Design

Shiva was written completely in the programming language “Java” and is able to run on all platforms. Shiva was written in an object oriented manner with encapsulation and re-use in mind. Shiva uses a client server architecture to achieve distributed computing and parallel searching. ShivaClient resides on the user machine. ShivaServer resides on the various servers. ShivaServer is continuously running as a daemon on the servers.

classes: Shiva Client

ShivaClient—contains the main function.

ShivaClientFrame1—handles the user-interface.

Hit—stores data regarding a single database hit.

SearchResult—stores data on compiled hits from a database search.

SearchThread—a single search job, a thread that controls all aspects of the search.

SearchThreadHandler—a thread that maintains the queue of SearchThread objects.

ConnectionHandler—a thread maintains socket connections to the distributed servers and controls serialization of data to and from the servers.

SearchParam—contains the search parameters, mass list to be searched and a thread to carry out the search, is serialized between the client and the server and contains all the search logic.

classes: Shiva Server

ShivaServer—contains the main function, listens for incoming connections.

Hit—as described above

SearchResult—as described above

SearchParam—as described above

SearchHandler—serializes search data, launches search returns results.

Program Flow

The ShivaServer should be running on the various server machines prior to searching. When lauched ShivaClient creates a ShivaClientFrame1 object which implements the user interface and reads the shiva.config file to determine which databases are up and running on the system.

The user chooses the file that contains the MS data in the form of the masses and intensities of all the ions and their respective fragmentation patterns. When launched, ShivaClient fills in the user defined variables on the user interface with default values which are given in the config file. The user may change these values by clicking on a text box and entering the desired values, which are primarily peptide modifications the user may include in the search:

Match at least—is the number of peptides required to match the same protein for the system to consider the protein a hit.

Tolerance—is the window of peptide masses pulled from the oracle database that may match the peptide being searched

Ion Tolerance—is used when analyzing the actual ms/ms spectra it is the allowable error of the actual fragmentation ion from the theoretical.

Ion Threshold—is the minimum intensity value a fragmentation ion in the ms/ms spectra must have to be used by the program.

Print Top—is the number of hits the program will print in the output .html file.

C13/C12 ratio. Shiva uses the relative intensities of the C12 and C13 peaks of a fragmentation ion to determine if an ion is a true y-ion or merely some other non-specific fragmentation or noise. If the intensity of the C13 peak of a fragmentation ion is equal to or greater than the value the peak is considered a y-ion fragment. The use of this value is important to the success of the algorithm, particularly in noisy datasets. This value will rarely have to be changed, as its value is dependent on the set up of the mass spectrometer.

ShivaClientFrame1 creates a “SearchThreadHandler” object which monitors a queue to determine if any jobs are waiting to be started. The user begins a search by opening Shiva client, in which the ShivaClientFrame1 object creates a “SearchThread” object, intializes the object with the user defined search parameters and places the “SearchThread” object in the queue. The “SearchThreadHandler” periodically checks the queue to see if it is empty. If the list is not empty the “SearchThreadHandler” object removes a “SearchThread” object from the top of the list, starts the internal thread of the “SearchThread” object and waits until its completed. Shiva only performs one search at a time.

Once started the “SearchThread” object takes over the search freeing the UI so the user may queue another search. The “SearchThread” object then opens and reads the file containing the mass spec data and for each peptide (ion) creates a new “SearchParam” object which holds the data as well as the search parameters and is stored in a list. The “SearchThread” object then reads the shiva.config file to find out the ip addresses of the machines with ShivaServer running, as well as the ports they are listening on. The “SearchThread” object then creates a new “ConnectionHandler” object for each server, initializes the “ConnectionHandler” object with the location of the list of “SearchParam” objects and starts the internal thread within the “ConnectionHandler” object. Creating a dedicated thread to communicate with a server is a simple and fast method to implement single client multi-server communication.

Once all the “ConnectionHandler” objects have been created they are assigned to a thread group. The “SearchThread” object waits until the thread group is finished. The “ConnectionHandler” threads then take over. Each “ConnectionHandler” thread opens a socket connection to a server, removes a “SearchParam” object from the top of the list and using the object serialization protocol sends the entire “SearchParam” object to the server over the network. The “ConnectionHandler” object then waits until the server returns a signal that it has finished searching the peptide, checks the list to see if more “SearchParam” objects are available, if so removes another “SearchParam” object from the list and sends it to the server. This process continues until all the “SearchParam” objects have been sent.

Server Side:

When launched, ShivaServer reads the server.config file to find out the connection string to the relational database, the userid and password and the port to listen on. ShivaServer then creates a serversocket that listens for incoming connections on the appropriate port. When as incoming connection is encountered ShivaServer creates a new “SearchHandler” object which opens the socket connection and launches its own internal thread. This architecture was chosen so that a single ShivaServer network could service multiple ShivaClient requests from different users by simply spawning new threads for new client connections. The “SearchHandler” object re-creates the incoming “SearchParam” object from serialization, launches the internal thread of the “SearchParam” object and waits until the “SearchParam” thread completes before returning the “SearchParam” object to the client over the network through the socket connection.

The “SearchParam” object then takes over the search. It opens a connection to the relational database, constructs and executes the sql statement, and receives the “ResultSet” object returned by the database. The database contains two tables one containing all the tryptic peptides found in a given protein database and their predetermined masses, the other table containing the one line annotation information. The tryptic peptide table is sorted and indexed on mass to facilitate the fastest search times. The “ResultSet” object contains all the records from the peptide table which were within the mass window. The “SearchParam” thread then iterates through the records parsing the peptide sequence to create a theoretical fragmentation pattern for each peptide. Any theoretical fragmentation ion which is outside the mass spec window is discarded.

The thread then compares the theoretical fragmentation pattern of every peptide in the result set with the observed fragmentation pattern from the input file. This is done by first sorting the theoretical fragmentation masses and then comparing masses individually against the entire array of observed masses. If a mass is found within the ion tolerance window and whose intensity is above the ion threshold (the primary match) then the thread moves backwards up the observed mass array again looking for a fragment ion 1 mass unit (+/− the ion tolerance) larger than the original match. If this secondary match is found its intensity is measured. If the intensity is found to be greater than or equal to the user defined C13/C12 ion ratio the search for this fragment ion is determined to be completed with success, scored according to the C31/C12 probability profile and the score for the peptide is multiplied by 0.05. All peptides are given an initial score of 1.0 and with each subsequent fragment ion match the score becomes the product of the original score and 0.05.

The score of 0.05 was chosen for the following reasons. In an ideal situation the mass spec data would be a clean y-ion spectra showing nothing but the observed sequence of the peptide in the experiment. By excluding noise below the ion threshold and finding only those fragment masses with y-ion characteristics (i.e. C13 or even possibly C14 peaks with the appropriate intensities), a situation is created that approximates the ideal. In an ideal situation the amino acid difference looked for is 1 in 20 (0.05), all things being equal.

This searching and scoring process only occurs for half the length of the theoretical peptide. This is know as the “tag” region of the peptide because it yields the best signal to noise ratio since the rest of the spectrum tends to contain all the various side fragmentation information thus cluttering the y-ion pattern.

Once the “SearchParam” object has completed its search the database connections are closed and the thread terminates. The waiting “SearchHandler” thread wakes up stores the completed “SearchParam” object and signals through the socket connection to the client that the server is ready for another “SearchParam” object.

When all the “SearchParam” objects have been sent the “ConnectionHandler” objects on the client side sends a signal to the servers indicating the search is complete. Upon receiving the signal the “SearchHandler” objects on the server side then send their arrays of “SearchParam” objects back to the “ConnectionHandler” threads waiting on the client side. The “ConnectionHandler” threads then store the “SearchParam” objects in a single central list of search results along with all the other “ConnectionHandler” threads. When all results are received the socket connections are closed and the thread group terminates. This wakes up the “SearchThread” object which goes through the list of “SearchParam” objects performing a tally and storing the results of each identification in a “SearchResult” object discarding those with fewer than the user defined number of matching peptides. The thread then sorts the list of results according to the peptide fragmentation score, discards those hits not within the user defined hits with the highest score and not having a sufficient significance score, connects to the relational database and downloads the annotation information for those remaining hits. The “SearchThread” then prints the results and score (the reciprocal of the peptide score), for example, in html format, and frees all resources.

Database

The database server, for example, Oracle, is one of the key elements to the speed of the system. By compartmentalizing the data to a dedicated server which can optimize queries, sort and index the data, and optimize data layout and caching, the Shiva software system leverages existing specialized software to achieve maximum speed while at the same time utilizing another computer's resources to do the work. There are various simple software tools known in the art to format the data and populate the database tables.

The following is an example of the database schema:

x_tryptic_peptides (

id number(32) primary key,
mass number(9,4),
name varchar2(32),
modification int(8),
peptide varchar2(255)

x_info

id number(32) primary key,
name varchar2(32),
pl number(3,2),
mw number(7,1),
description varchar2(255)

Deployment

ShivaClient and ShivaServer are deployed as jar (java archive) files which are essentially .zip files containing the compressed class files for the application to function. All that is need is the .jar file and the config file to install Shiva on a machine. On Linux/Unix machines the files are usually installed in the /usr/local/shiva/ directory. On Microsoft Windows NT machines, the Shiva program is usually installed in the c:\shiva\ directory For such machines a ShivaServer.bat or ShivaClient.bat file is also installed in the same directory and a symbolic link is dragged into the Programs folder of the Start menu. The .bat files contain the following:

for the Shiva Server:

set JREPATH=c:\jdkl.x\jre\bin

set CLASSPATH=c:\shiva

%JREPATH%\javaw -jar -mx64m %CLASSPATH%\ShivaServer.jar -config=server.config

for the Shiva Client:

set JREPATH=c:\jdk1.x\jre\bin

set CLASSPATH=c:\shiva

%JREPATH%\java -jar -mx128m %CLASSPATH%\ShivaClient.jar -config=shiva.config

Shiva requires the jdk or jre to be installed on the host machine. The application paths indicated above are dependent upon the installation paths on the respective machines. For Microsoft Windows NT the jdk (or jre) is usually installed in c:\jdk1.x.x. For Linux/Unix machines the jdk (or jre) is usually installed in /usr/local/jdk1.xx.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A method of searching for a mass spectral proteomics data match in a reference database using a server high speed identification algorithm, wherein a local area network is used as a virtual parallel processor distributing the search over multiple computers in a network, the method comprising:
forming a query comprising input data obtained from an individual peptide using a client module,
connecting to multiple remote servers;
sending said input data from said client module over a LAN to said multiple remote servers; wherein said multiple remote servers normalize and filter said input data, and performing a query against a central database; and send an array containing all the database matches back to the client.

2. The method of claim 1, wherein said spectral proteomics data is ms/ms data from mass spectroscopy.

3. The method according to claim 2, wherein said query comprises the steps of:
(a) calculating the mass of the parent ion
(b) querying a central database is queried with said mass;
(c) returning names, masses and sequences of the tryptic peptides with a mass within user defined tolerance of the query mass;
(d) generating a theoretical ms/ms spectrum of each hit;
(e) searching each mass in the hit against the input data for matches;
(f) searching said matches for a corresponding isotope, wherein if a mass match is found, a search is initiated for the next isotope;
(g) assigning a score for a match based on a pre-calculated probability profile of the intensities of the isotopic peaks;
repeating steps (a) through (g) for each element of a theoretical spectra within a tag region corresponding to amino acids within the N-terminal half of said peptide;
assigning a score for a peptide that is the product of probabilities for finding each amino acid in question multiplied by the score of the match as determined by the probability profile less the probability of the mass spectral data matching a randomized peptide;
assigning a significance score described as the number of standard deviations the score is from the score of the randomized peptide.

4. The method according to claim 3, wherein the client program compiles the hits from all the servers into a search result file, and aggregates scores for each search result calculated as the product of the scores from the top peptide hits.

5. The method according to claim 4, wherein the result is formatted as an output file readable by a viewer program.

6. The method according to claim 3, wherein the client program formulates a query by the steps comprising:
creating a SearchThread object
initializing the object with the user defined search parameters
placing the searchThread object in a queue.

7. The method of claim 6, wherein a SearchThreadHandler performs the steps comprising:
checking said queue, and if said queue is not empty;
removing a SearchThread object from the top of the list;
starting the internal thread of the SearchThread object; and
waiting until said internal thread is completed.

8. The method of claim 7, wherein the SearchThread object performs the steps comprising:
opening and reads said input file;
creating a SearchParam object that holds said data and said search parameters
reading a configuration file to determine available server machines;
creating a ConnectionHandler object for each server;
initializing said ConnectionHandler object with the location of said SearchParam objects
starting the internal thread within said ConnectionHandler object, wherein each ConnectionHandler thread opens a socket connection to a server, removes a SearchParam object from the top of the list and using the object serialization protocol sends the entire SearchParam object to the server over the network.

9. The method according to claim 8, wherein said SearchParam object performs the steps comprising:
opening a connection to a central database
constructing and executing a search statement;
receiving a resultset comprising results of said search returned from said database.

10. The method according to claim 9, wherein said connectionhandler performs the steps of:
sending a signal to all servers when all SearchParam objects have been received by the client, to indicate the search is complete; wherein each SearchHandler object then creates an array of SearchResult objects for each protein encountered as a hit, and sends said arrays back to the ConnectionHandler threads
storing said SearchResult objects in a central list.
